(19) United States
(12) Patent Application Publication
(10) Pub. No.: US 2008/0063761 A1
(43) Pub. Date: Mar. 13, 2008

(54) Processed Flour Food Containing Added Bilberries and Method of Coloring The Food

(76) Inventor: Shinichi Saito, Inzai-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/573,377

(22) PCT Filed: Aug. 5, 2005
(86) PCT No.: PCT/JP05/14803

§ 371 Date: Oct. 4, 2007

(30) Foreign Application Priority Data
Sep. 2, 2004 (JP) 2004-255370

(51) Int. Cl. A23L 1/275

(52) U.S. Cl. 426/250

(57) ABSTRACT

An object of the present invention is to provide a processed flour food which is excellent in safety and cost respects and which contains added bilberries capable of stably coloring the processed flour food bluish purple, and a method of coloring the food. The present invention is directed to a processed flour food containing added bilberries, to which bilberries are added in an amount of 5% to 30% with respect to a weight of all materials to color the processed flour food bluish purple, and as a method of coloring a processed flour food containing added bilberries, the method being characterized by comprising: a harvesting step of freezing picked bilberries and then removing foreign matters therefrom; a processing step of crushing the frozen bilberries after the harvesting step and adding an aroma and sugar to the bilberries to mix them; a storing step of sterilizing each constant amount of the packed bilberries after the processing step and passing the bilberries through a metal detector to store the frozen bilberries; and a using step of thawing the bilberries after the storing step to blend the bilberries with the processed flour food.

### TECHNICAL FIELD

The present invention relates to a processed flour food containing added bilberries which color a dough or the like brightly bluish purple and a method of coloring the food.

### BACKGROUND ART

Heretofore, bluish purple breads, sweets and the like have been very popular, but most of them have been colored with an artificial coloring agent. The coloring has also been tried by utilizing food materials including anthocyanin dyestuffs such as blueberries, red wine and purple sweet potatoes.

Especially, the blueberries are excellent in view of health functionalities such as an eyesight improvement effect and an antioxidant function, and refreshing feelings of the blueberries excite customers' curiosities. Moreover, in recent years, health consciousness has risen, and utility and palatability have also been noticed.

As in an invention described in Japanese Patent Application Laid-Open No. 2003-199481, an invention is made public in which the food material including an anthocyanin dyestuff such as the red wine is added to a bakery dough to thereby color the bakery dough purple.

However, food can be colored bluish purple with the artificial coloring agent, but there is also an artificial coloring agent having a reported possibility of developing a cancer or inducing an allergy, and many customers are natural resource or nature-oriented in order to protect themselves in many cases.

Even in a case where the food material including the anthocyanin dyestuff is added, the food can be colored in a range from a reddish brown color to a burgundy color in an acid region which is red. However, in an alkali region which is blue and purple, stability deteriorates. Even if the food is forcibly colored, it only turns dirty gray. Since acidity is increased using a lemon juice or the like to adjust pH, operability is not satisfactory.

When a large amount of crushed raw blueberries are added to the bread and the like, blueberry peelings are scattered in the dough so that the bread looks bluish purple, but the dough itself is gray. In addition, threefold to fivefold expenses are required as compared with ordinary breads and the like. In a case where a blueberry juice, puree, or concentrate of the juice or the puree is used in a processed flour food, the food only turns brown and cannot be colored brightly bluish purple.

Therefore, an object of the present invention is to provide a processed flour food which is excellent in safety and cost respects and which contains added bilberries capable of stably coloring the processed flour food bluish purple, and a method of coloring the food.

### DISCLOSURE OF THE INVENTION

To solve the above problem, the present invention has been developed. A first aspect of the invention is directed to a processed flour food containing added bilberries, characterized in that bilberries are added in an amount of 5% to 30%, preferably 10% to 18% with respect to a weight of all materials to thereby color the processed flour food bluish purple. A second aspect of the invention is directed to a method of coloring a processed flour food containing added bilberries, the method being characterized by comprising: a harvesting step of freezing picked bilberries and then removing foreign matters therefrom; a processing step of crushing the frozen bilberries after the harvesting step and adding an aroma and sugar to the bilberries to mix them; a storing step of sterilizing each constant amount of the packed bilberries after the processing step and passing the bilberries through a metal detector to store the frozen bilberries; and a using step of thawing the bilberries after the storing step to blend the bilberries with the processed flour food.

### BRIEF DESCRIPTION OF THE DRAWINGS

FIG. 1 is a flow chart showing a processed flour food of the present invention containing added bilberries, and a flow of a method of coloring the food;

FIG. 2 is a list showing processed flour foods of the present invention containing added bilberries, and amounts to be added during blending with various breads in a method of coloring the foods;

FIG. 3 is a list showing processed flour foods of the present invention containing added bilberries, and amounts to be added during blending with various breads in a method of coloring the foods; and

FIG. 4 is a list showing processed flour foods of the present invention containing added bilberries, and amounts to be added during blending with various sweets in a method of coloring the foods.

### BEST MODE FOR CARRYING OUT THE INVENTION

A processed flour food of the present invention containing added bilberries will hereinafter be described in detail. The processed flour food containing the added bilberries is characterized in that the bilberries are added in an amount of 5% to 30%, preferably 10% to 18% with respect to a weight of all materials to color the processed flour food bluish purple.

The bilberries are a fruit which belongs to the Vaccinium genus of the Ericaceae family in the same manner as in blueberries, grow wild mainly in low lands from Scandinavian Peninsula to Northern Europe, and are also called the blueberries or forest blueberries in some case. However, the bilberries belong to the Myrtillus section, and the blueberries belong to the Cyanococcus section. Therefore, strictly speaking, they are separately classified.

The bilberries are smaller than the blueberries, and have a very acid taste. The bilberries contain quite a lot of anthocyanin dyestuffs as compared with the blueberries or the like, and most of the dyestuffs are contained especially in peelings. It is to be noted that the anthocyanin dyestuff has multiple health functionalities, and is safe without giving any toxic side effect. The bilberries have a health functionality effect about twice to five times that of blueberries.

The health functionalities of the bilberries include an eyesight improvement effect, and improvement of vision in the dark and alleviation of eye strains are recognized. The bilberries are effective for a treatment of diabetic retinopathy, and can prevent cataract.

In a chilled temperature zone (around 0° C. or less), the bilberries have an antioxidant function of keeping the anthocyanin dyestuffs, and suppresses active oxygen which causes an oxidation trouble of fat, protein or nucleic acid related to cancer, cardiovascular disease or another morbid trouble.

The bilberries are small. In addition, since the raw bilberries are utilized, a high ratio of peelings is achieved, quite an abundance of dietary fibers are contained, and an intestine regulating function and prevention of large intestine cancer can be expected. An abundance of minerals are also contained, especially remarkably large amounts of zinc and manganese are contained as compared with another fruit, and vitamins are also contained on average.

A rise of capillary permeability is a secondary cause of many diseases, but the bilberries have an effect of improving the permeability of the capillary and strengthening a fragile capillary. The bilberries also have an effect of inhibiting platelet aggregation, and can prevent thrombosis or arterial sclerosis.

The anthocyanin dyestuff has a function of controlling an enzyme function of rapidly proliferating cancer cells, and an anticarcinogenic effect is also recognized. Proliferation of bacterial groups attached to membrane walls of bladder and ureter can also be prevented. Furthermore, a cartilage portion, a tendon or the like mainly consisting of a collagen is strengthened, and an enzyme which destroys an inflaming collagen is hampered to thereby promote synthesis of the collagen.

To add the bilberries to the processed flour food, purees are suitable, but a bilberry liquid, solid or paste such as juice, paste, sauce, concentrate, fruit, frozen article, chilled article, spray-dried article, granulated article, freeze-dried article or drum-dried article may be used as long as it can be mixed with a dough.

It is to be noted that spray-drying is a drying process of spraying a liquid food in an air current at a high temperature to dry the food, granulation is a drying process of solidifying powder and forming it into granules, freeze-drying is a drying process of freezing an object to dispose the object in vacuum and subliming a moisture to remove the moisture therefrom, and drum-drying (cylinder rotating type drying) is a drying process of thinly coating a heated rotary cylinder with the liquid or paste food and momentarily drying the food.

Moreover, there is not any problem in a processed article in which the bilberries are used as a main material or a quasi material and to which the blueberries, water, sugar and the like are added, such as jam or flour paste, as long as it can be mixed with the dough.

It is to be noted that the flour paste is paste obtained by using, as a main material, flour, starch, nuts or a processed article of the nuts, cocoa, chocolate, coffee, or fresh or juice of fruit; adding sugar, fat/oil, powder milk, egg, flour and the like to the material; heating and sterilizing the material; forming the material into the paste; and filling or coating a bread or a sweet with the paste to use the paste for food.

Examples of the processed flour food include the bread, confectionery, Japanese cake, a snack, and noodles such as wheat noodles, buckwheat noodles and pastas, and they are supplied in the form of a baked article, a semi-baked article, a frozen dough, a refrigerated dough or mixed powder.

Examples of the bread include a roll of butter bread, a loaf of bread, the French bread, the English muffin, a sweet bun, a melon coating, a yeast doughnut, a brioche, a croissant, the Danish pastry, a pastry, the American muffin, the Chinese bread, a bagel, a doughnut and an artisan bread.

Moreover, examples of the confectionery include a pound cake, a steamed cake, a sponge cake, a pancake, a biscuit, a waffle, a cream puff pastry, a scone, the Castella sponge cake, and a cookie.

Materials of the processed flour food mainly include flour, yeast, baking powder, eggs, butter, sugar, salt, water and the like. It is to be noted that if necessary, various materials are mixed with the dough to obtain varieties of processed flour foods.

As the flour, hard flour, medium flour, soft flour, whole-grain flour or rice flour can be utilized. Examples of the yeast include a dry yeast, a raw yeast, a natural yeast and a dough ingredient. The baking powder is a swelling agent, and can be replaced with a baking soda, ammonium hydrogen carbonate, burnt alum or the like.

As the egg, whole egg, egg yolk or egg white can be used. A sweetened egg, a dried egg, a frozen egg or an egg treated with the enzyme can be used. The butter may be replaced with margarine, shortening, vegetable oil/fat, animal oil/fat or the like.

As the sugar, white superior soft sugar, granulated sugar, powder sugar, grape sugar, fruit sugar, cane sugar, malt sugar, milk sugar, oligosaccharide, trehalose, xylitol, stevia or honey can be used.

To leaven the bread, a sugar content is required as a source of nutrition of the yeast. Since the bilberries contain pectin, leavening and finishing of the bread are improved. It is to be noted that pectin is polysaccharide broadly contained in vegetables, and is for use in manufacturing jam, marmalade, jelly or the like.

A sugar content such as pectin performs a function of accelerating the leavening as a nutrient content of the yeast. In addition, a function of mildening the finished bread, a function of inhibiting the bread from being old to keep the bread for a long time, or a function of improving a moisture retaining property or a resistance to mechanical processing can be expected.

The bilberries produce a red juice when crushed. In a case where the bilberries are mixed with the flour to make the bread, since the bilberries react with starch of carbohydrate contained in the flour, the bread turns very bright bluish purple. The bilberries have an acidity which is as high as pH of about 2.0, and can prevent discoloration due to alkalization.

When a large amount of a material having alkalinity such as egg white, milk or baking powder is used, there is a possibility of the discoloration. Therefore, this possibility can be eliminated by a method such as a method of reducing an amount to be used or a method of changing a processing procedure.

When a raw material of the butter or the margarine is replaced with fermented milk, a mild acidic effect develops. When a slightly larger amount of the egg yolk indicating weak acidity is used as the egg rather than the egg white indicating the alkalinity, a degree of discoloration can be reduced.

The bilberries are used in an amount of 20 to 60% with respect to a weight of the flour, and an appropriate amount is 5 to 30% for the processed flour food. In consideration of a tint or cost respect, a preferable amount is 10 to 18% with respect to a weight of the processed flour food.

For example, a usual cost price of a loaf of bread is around 50 yens, and a selling price is 160 to 240 yens. In a case where the blueberries are added, a large amount of the blueberries need to be added. Therefore, a cost price of the bread is 180 to 250 yens, and a selling price is 540 to 1250 yens.

In a case where the bilberries are added, a cost price per loaf is 120 to 130 yens, and a selling price is 360 to 650 yens. The cost price can be reduced as much as 27 to 52% as compared with the blueberries. A commercial use value remarkably improves.

In a case where the bilberries are mixed as the puree with the bread or the like, even if the bread is heated at a temperature as high as 200° C. or more for 40 minutes or more, a brightly bluish purple color can be obtained without being discolored. Even in a case where the bilberries are mixed as health drink with water, the water can stably be colored bluish purple.

It is considered that the bilberries are broadly applicable, as a natural coloring agent capable of coloring the food bluish purple, to a food other than the processed flour food, beverage, feedstuff, cosmetic, medical supply and the like.

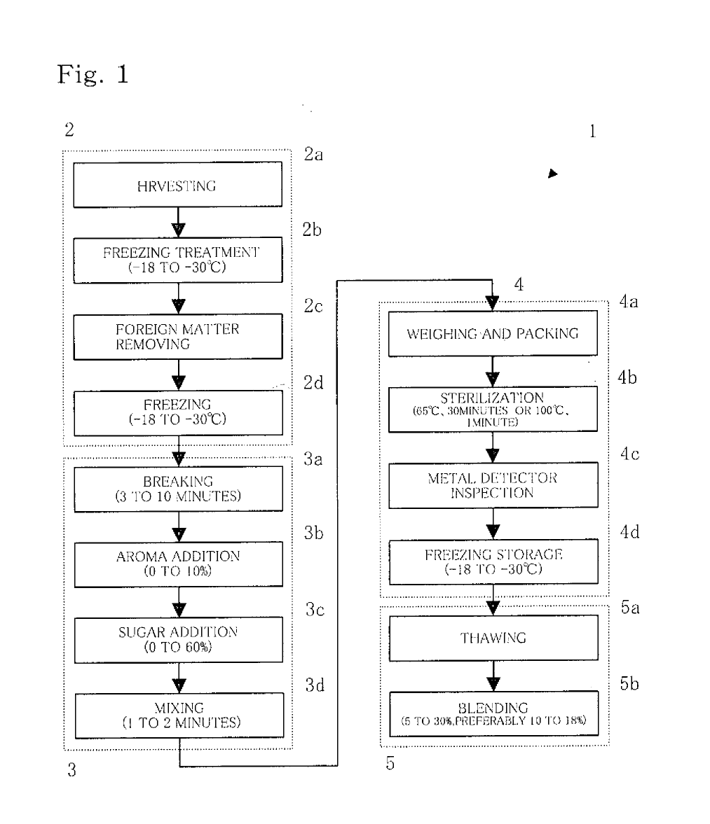

A method of coloring the processed flour food containing the added bilberries will be described as the present invention in detail with reference to the accompanying drawings. FIG. 1 is a flow chart showing the processed flour food of the present invention containing the added bilberries and a flow of a method of coloring the food.

The method of coloring the processed flour food containing the added bilberries includes a harvesting step 2 of freezing picked bilberries before removing foreign matters therefrom; a processing step 3 of crushing the bilberries frozen after the harvesting step 2 and adding an aroma and sugar to the bilberries to mix them; a storing step 4 of sterilizing each constant amount of the packed bilberries and passing the bilberries through a metal detector to store the frozen bilberries; and a using step 5 of thawing the bilberries after the storing step 4 to blend the bilberries with the processed flour food.

The harvesting step 2 includes harvesting 2a, freezing treatment 2b, foreign matter removing 2c and freezing 2d. During the harvesting 2a, the bilberries are picked, washed with water in order to remove dirt therefrom, then put in a box having a satisfactory air permeability and dried with sent air.

It is to be noted that since the washing has a possibility that the anthocyanin dyestuff comes out of the peelings of the bilberries, the washing is sometimes omitted. The bilberries which naturally grow wild are used. Therefore, they are not brought into contact with any agricultural chemical or the like, and there is not any food hygienic problem.

During the freezing treatment 2b, the picked bilberries put in the box having the satisfactory air permeability are frozen at a temperature of minus 18° C. to minus 30° C., and stored. This prevents the bilberries from being crushed. Since the berries themselves are hardened, operability improves.

During the foreign matter removing 2c, the frozen bilberries are uniformly scattered with a crushing machine. Subsequently, the foreign matters are removed therefrom by a method such as leaf removing, stem removing, size selection, a ripeness inspection, a laser removing device, on-the-spot visit or an inspection with a metal detector.

During the leaf removing, strong wind is applied to the bilberries with a blower to remove foreign matters such as branches and leaves therefrom. During the stem removing, the bilberries are mounted on a meshed belt, and vibrated to thereby remove small stems attached to the bilberries therefrom.

During size selection, the bilberries are rolled on rollers arranged at constant intervals, and the bilberries having sizes which do not meet the standard and the other foreign matters are allowed to fall and removed therefrom. In the ripeness inspection, laser is applied to each of the bilberries, ripeness is judged by color, and the bilberries which do not meet the standard are removed therefrom with an air gun or the like.

The laser removing device applies laser from two directions, and removes all spherical matters such as stones and plastics except the bilberries. In the on-the-spot visit, a plurality of staff members manually checks whether or not the foreign matters are mixed.

During the freezing 2d, the bilberries from which the foreign matters have been removed are frozen at a temperature of minus 18 to minus 30° C. This is performed in order to store or circulate the bilberries until the processing step 3 is performed, and finely crush the bilberries in the processing step 3.

The processing step 3 includes breaking 3a, aroma addition 3b, sugar addition 3c and mixing 3d. During the breaking 3a, the frozen bilberries are finely crushed with a mixer or the like for three to ten minutes. However, a required time differs with a performance of a machine or an amount of the bilberries to be put. As compared with the raw bilberries are ground, in a case where the bilberries are frozen, the bilberries including the peelings can simply be pulverized.

It is to be noted that after the frozen bilberries are thawed, the breaking 3a can be performed. However, in a case where they are thawed, cell destruction is caused, and components might flow out. Therefore, in respect of quality and time, it is preferable to subject the frozen bilberries to the breaking 3a.

After the breaking 3a, the bilberries are sometimes filtered. The foreign matters can further be removed therefrom, but the peelings to which a lot of anthocyanin dyestuffs have been attached are removed and reduced. Therefore, the filtering can be omitted.

During the aroma addition 3b, 0 to 10% of aroma is added to the bilberries. During the sugar addition 3c, 0 to 60% of sugar content is added to the bilberries. During the mixing 3d, the bilberries containing the added aroma and sugar are mixed well for one to two minutes.

Amounts of the aroma and the sugar content to be added can be adjusted if necessary, or any of them does not have to be added. This is because a confectionery plant or a natural food shop sometimes dislikes any additive or wants to add the aroma by themselves.

The storing step 4 includes weighing and packing 4a, sterilization 4b, metal detector inspection 4c and freezing storage 4d. During the weighing and packing 4a, the processed bilberries are relocated to a heat resistant container, and the bilberries are packed while each constant amount is weighted.

During the sterilization 4b, the packed bilberries are heated and sterilized. Examples of a method of the sterilization includes low-temperature sterilization in which the bilberries are left to stand at a temperature of 62 to 65° C. for about 30 minutes, high-temperature sterilization in which they are left to stand at a high temperature of about 100° C. for about one minute, and super high temperature short time sterilization in which they are left to stand at a temperature of 120 to 130° C. for about two seconds. After the sterilization 4b, the bilberries are cooled.

During the metal detector inspection 4c, metals and the like are removed from the bilberries by use of the metal detector. It is finally checked whether or not the foreign matters might be mixed. During the freezing storage 4d, the bilberries are frozen at minus 18 to minus 30° C., and they are stored or circulated until the using step 5 is performed.

The using step 5 includes thawing 5a and blending 5b. During the thawing 5a, the bilberries are thawed in a refrigerator overnight before used. It is preferable that after opening a pack, the remaining bilberries are refrigerated and stored at 0 to 10° C. and that they are used up within three days if possible.

During the blending 5b, the bilberries subjected to the thawing 5a are blended with the processed flour food. When 5% to 30%, preferably 10% to 18% of bilberries are added to the total weight of the processed flour food, the processed flour food can be colored brightly bluish purple.

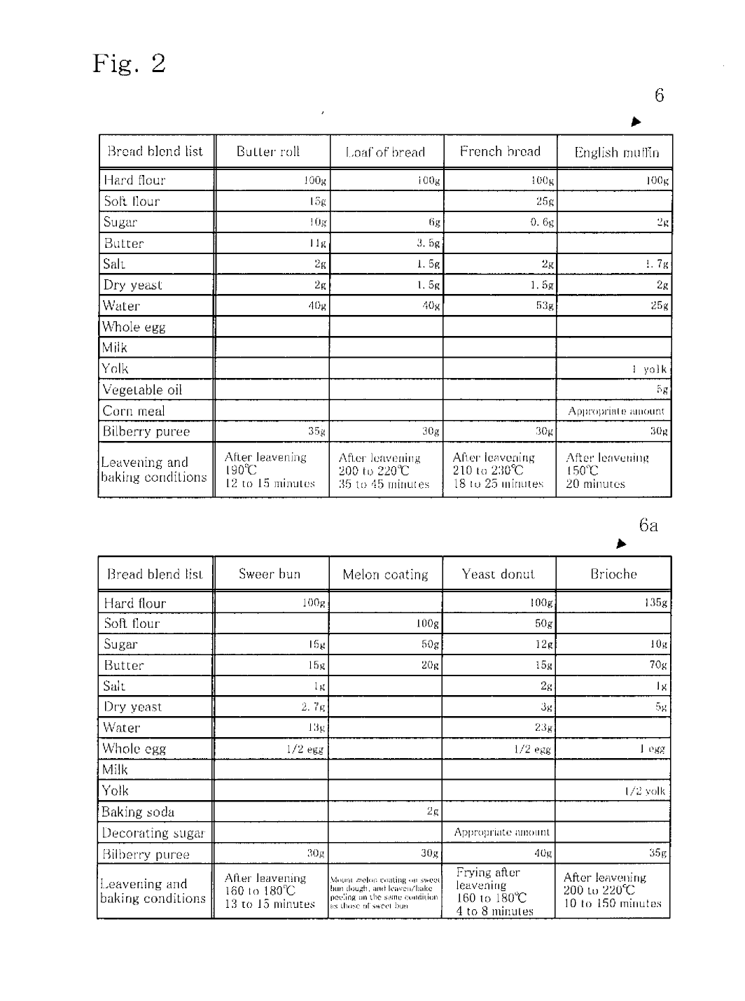

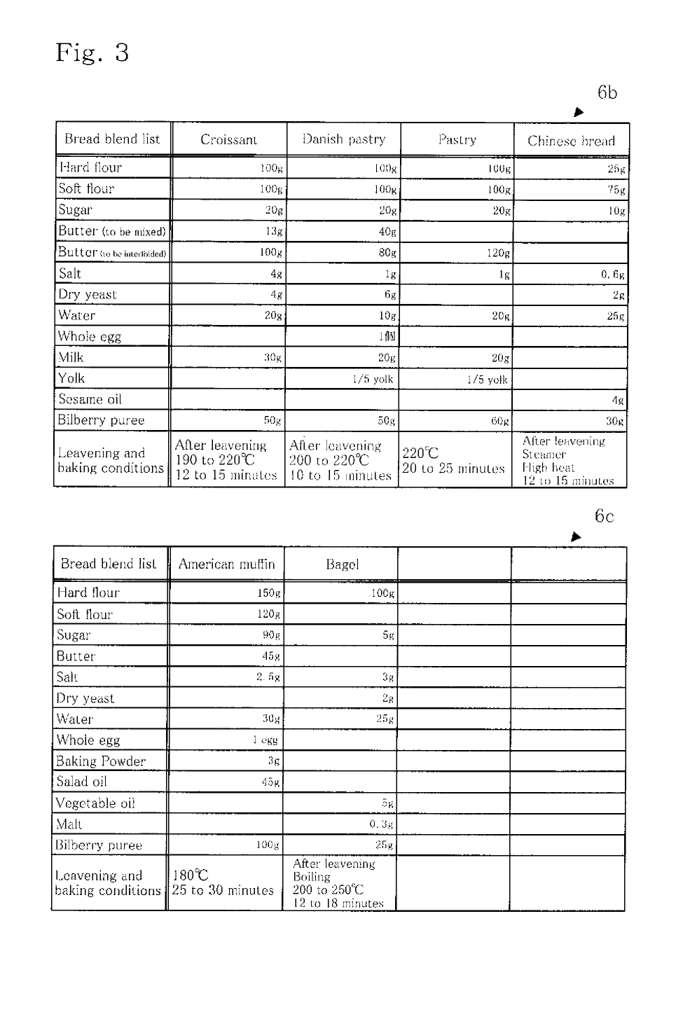

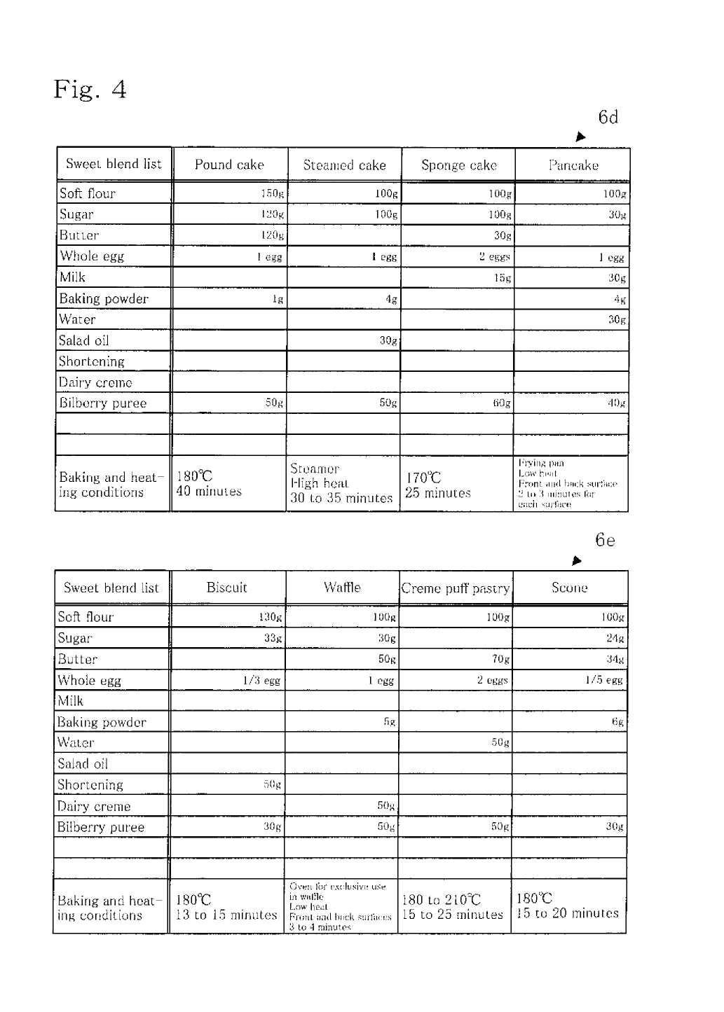

FIGS. 2 and 3 are lists of amounts to be added during the blending of the bilberry puree with various breads in the present invention, and FIG. 4 is a list of amounts to be added during the blending of the bilberry puree with various sweets in the present invention.

It is to be noted that the amounts to be added and the like shown in FIGS. 2, 3 and 4 are merely rough standards, and they sometimes differ. There is hardly a case where materials, blend ratios or procedures are the same, a detailed method of manufacturing the processed flour food slightly differs with each company, person, shop or the like, and a name of the processed flour food or the like sometimes differs with district.

Various breads and sweets shown in FIGS. 2, 3 and 4 are examples of the processed flour food. Even when the constant amount of the bilberries are added to other various processed flour foods, the anthocyanin dyestuffs included in the bilberries react with the flour, and the flour can be colored brightly bluish purple.

A bread blend list 6 shows amounts of materials to be added and leavening and baking conditions, the materials being to be blended with the roll of butter bread, the loaf of bread, the French bread and the English muffin. A bread blend list 6a shows amounts of materials to be added and leavening and baking conditions, the materials being to be blended with the sweet bun, the melon coating, the yeast doughnut and the brioche. A bread blend list 6b shows amounts of materials to be added and leavening and baking conditions, the materials being to be blended with the croissant, the Danish pastry, the pastry and the Chinese bread. A bread blend list 6c shows amounts of materials to be added and leavening and baking conditions, the materials being to be blended with the American muffin and the bagel.

The materials of the roll of butter bread are 100 g of hard flour, 15 g of soft flour, 10 g of sugar, 11 g of butter, 2 g of salt, 2 g of dry yeast and 40 g of water. When 35 g of bilberry puree is added, the bread can be colored bluish purple.

A procedure of manufacturing the roll of butter bread is as follows. All the materials including the bilberry puree are mixed until gluten of the flour is optimized. The materials are put in a casing so that they do not dry, and the casing is covered with a lid to perform primary leavening in a place at about 30° C. for 40 to 50 minutes until a size of the dough becomes two-fold to 2.5-fold. The dough is divided and rested for about ten minutes. The dough is shaped and arranged on a baking sheet to perform secondary leavening in a place at about 30° C. for 30 to 40 minutes until the size of the dough becomes doubled. After the leavening, the dough is coated with an egg for glazing, and baked at 190° C. for 12 to 15 minutes.

The materials of the loaf of bread are 100 g of hard flour, 6 g of sugar, 3.5 g of butter, 1.5 g of salt, 1.5 g of dry yeast and 40 g of water. When 30 g of bilberry puree is added, the bread can be colored bluish purple.

A procedure of manufacturing the loaf of bread is as follows. All the materials including the bilberry puree are mixed until gluten of the flour is optimized. The materials are put in a casing so that they do not dry, and the casing is covered with a lid to perform primary leavening in a place at about 30° C. for about 90 minutes until a size of the dough becomes two-fold to 2.5-fold. The dough is again rounded for breathing. Again, the dough is leavened at about 30° C. for 40 to 50 minutes. The dough is divided and rested for about 20 minutes. The dough is shaped so as to be put in a mold. After putting the dough in the mold, secondary leavening is performed in a place at about 30° C. for about one hour until the size of the dough becomes two-fold to 2.5-fold. After the leavening, the dough is baked at 200 to 220° C. for 35 to 45 minutes.

The materials of the French bread are 100 g of hard flour, 25 g of soft flour, 0.6 g of sugar, 2 g of salt, 1.5 g of dry yeast and 53 g of water. When 30 g of bilberry puree is added, the bread can be colored bluish purple.

A procedure of manufacturing the French bread is as follows. All the materials including the bilberry puree are mixed until gluten of the flour is optimized. The materials are put in a casing so that they do not dry, and the casing is covered with a lid to perform primary leavening in a place at about 30° C. for about 90 minutes until a size of the dough becomes two-fold to 2.5-fold. The dough is again rounded for breathing. Again, the dough is leavened at about 30° C. for 40 to 50 minutes. After molding the dough, secondary leavening is performed in a place at about 30° C. for 40 to 50 minutes until the size of the dough becomes doubled. After the leavening, a cut pattern referred to as a coup is made in the surface of the dough, and the dough is baked at 210 to 230° C. for 18 to 25 minutes under steam.

The materials of the English muffin are 100 g of hard flour, 2 g of sugar, 5 g of vegetable oil, 1.7 g of salt, 2 g of dry yeast, 25 g of water, one egg yolk and an appropriate amount of the cornmeal. When 30 g of bilberry puree is added, the muffin can be colored bluish purple.

A procedure of manufacturing the English muffin is as follows. All the materials including the bilberry puree are mixed until gluten of the flour is optimized. The materials are put in a casing so that they do not dry, and the casing is covered with a lid to perform primary leavening in a place at about 30° C. for about 90 minutes until a size of the dough becomes two-fold to 2.5-fold. The dough is again rounded for breathing. Again, the dough is leavened at about 30° C. for 40 to 50 minutes. The dough is divided and rested for about ten minutes. After molding the dough, the cornmeal is sprayed all over the dough. After the molding, secondary leavening is performed in a place at about 30° C. for 40 to 50 minutes until the size of the dough becomes doubled. After the leavening, the dough is baked at 150° C. for 20 minutes.

The materials of the sweet bun are 100 g of hard flour, 15 g of sugar, 15 g of butter, 1 g of salt, 2.7 g of dry yeast, 13 g of water and ½ of the whole egg. When 30 g of bilberry puree is added, the bun can be colored bluish purple.

A procedure of manufacturing the sweet bun is as follows. All the materials including the bilberry puree are mixed until gluten of the flour is optimized. The materials are put in a casing so that they do not dry, and the casing is covered with a lid to perform primary leavening in a place at about 30° C. for about 60 minutes until a size of the dough becomes two-fold to 2.5-fold. The dough is divided and rested for about ten minutes. The dough is extended, stuffed with an ingredient such as bean jam, cream or jam, and molded. Secondary leavening is performed for 20 to 30 minutes. After the leavening, the dough is baked at 160° C. to 180° C. for 13 to 15 minutes.

The materials of the melon coating are 100 g of soft flour, 50 g of sugar, 20 g of butter and 2 g of baking soda. When 30 g of bilberry puree is added, the peeling can be colored bluish purple. It is to be noted that the melon coating is a coating portion of a melon-tasted bread.

A procedure of manufacturing the melon coating is as follows. The butter is put in a bowl, and kneaded with a whisk until the butter is creamed. After adding the sugar, the materials are mixed while they become whitish. The soft flour, the baking soda and the bilberry puree are added and mixed. A finished topping dough is mounted on a sweet bun dough, and leavened and baked on the same conditions as those of the sweet bun. It is to be noted that the sweet bun dough in the melon coating may be constituted using water instead of the bilberry puree.

The materials of the yeast doughnut are 100 g of hard flour, 50 g of soft flour, 12 g of sugar, 15 g of butter, 2 g of salt, 3 g of dry yeast, 23 g of water, ½ of the whole egg and an appropriate amount of decorating sugar. When 40 g of bilberry puree is added, the doughnut can be colored bluish purple.

A procedure of manufacturing the yeast doughnut is as follows. All the materials including the bilberry puree are mixed until gluten of the flour is optimized. The materials are put in a casing so that they do not dry, and the casing is covered with a lid to perform primary leavening in a place at about 30° C. for about 50 minutes until a size of the dough becomes approximately doubled. The dough is divided and rested for about ten minutes. The dough is molded by die cutting. Secondary leavening is performed in a place at about 30° C. for about 40 minutes until the dough size becomes approximately doubled. After the leavening, opposite surfaces are fried at 160° C. to 180° C. for four to eight minutes. Finally, an appropriate amount of decorating sugar is applied. It is to be noted that instead of the yeast, a swelling agent such as the baking powder may be utilized. This can be applied to a doughnut made without being leavened.

The materials of the brioche are 135 g of hard flour, 10 g of sugar, 70 g of butter, 1 g of salt, 5 g of dry yeast, one whole egg and ½ of egg yolk. When 35 g of bilberry puree is added, the brioche can be colored bluish purple.

A procedure of manufacturing the brioche is as follows. All the materials including the bilberry puree are mixed until gluten of the flour is optimized. The materials are put in a casing so that they do not dry, and the casing is covered with a lid to perform primary leavening in a place at about 30° C. for about 60 minutes until a size of the dough becomes 1.5-fold to two-fold. If possible, the dough is put in a refrigerator half a day, and the materials are adapted to one another. The dough is left to stand in the refrigerator overnight. The dough is divided and rested for about ten minutes. The dough is put in a mold, and secondary leavening is performed for 20 to 30 minutes. After the leavening, the dough is baked at 200° C. to 220° C. for ten to 15 minutes.

The materials of the croissant are 100 g of hard flour, 100 g of soft flour, 20 g of sugar, butter (13 g of butter to be mixed with the dough, 100 g of butter to be interfolded in the dough), 4 g of salt, 4 g of dry yeast, 20 g of water and 30 g of milk. When 50 g of bilberry puree is added, the croissant can be colored bluish purple.

A procedure of manufacturing the croissant is as follows. All the materials including the bilberry puree are mixed until gluten of the flour is optimized. The materials are put in a casing so that they do not dry, and the casing is covered with a lid to perform primary leavening in a place at about 30° C. for about 50 minutes. However, since this blend is rich as compared with another dough, this dough hardly swells. The dough is put in a refrigerator and rested for 35 to 45 minutes. The butter to be interfolded is put in the dough removed from the refrigerator, and interfolded into several layers. The dough is again rested in the refrigerator for 35 to 45 minutes, cut into an isosceles triangle (a 10 cm long bottom side, a height of 20 cm), wound and tapered from the bottom side. Secondary leavening is performed at a temperature of 25 to 27° C. for 40 to 50 minutes. After the leavening, the dough is coated with an egg for glazing, and baked at 190° C. to 220° C. for 12 to 15 minutes.

The materials of the Danish pastry are 100 g of hard flour, 100 g of soft flour, 20 g of sugar, butter (40 g of butter to be mixed with the dough, 80 g of butter to be interfolded in the dough), 1 g of salt, 6 g of dry yeast, 10 g of water, one whole egg, 20 g of milk and ⅕ of an egg yolk. When 50 g of bilberry puree is added, the pastry can be colored bluish purple.

A procedure of manufacturing the Danish pastry is as follows. All the materials including the bilberry puree are mixed until gluten of the flour is optimized. The materials are put in a casing so that they do not dry, and the casing is covered with a lid to perform primary leavening in a place at about 30° C. for about 50 minutes. However, since this blend is rich as compared with another dough, this dough hardly swells. The dough is put in a refrigerator and rested for 35 to 45 minutes. The butter to be interfolded is put in the dough removed from the refrigerator, and interfolded into several layers. The dough is again rested in the refrigerator for 35 to 45 minutes, and formed into a spiral or bar shape, and ingredients are disposed in the center of the dough regarded as a dish. Secondary leavening is performed for about 25 minutes. After the leavening, the dough is coated with an egg for glazing, and baked at 200 to 220° C. for ten to 15 minutes.

The materials of the pastry are 100 g of hard flour, 100 g of soft flour, 20 g of sugar, 120 g of butter to be interfolded in the dough, 1 g of salt, 20 g of water, 20 g of milk and ⅕ of an egg yolk. When 60 g of bilberry puree is added, the pastry can be colored bluish purple.

A procedure of manufacturing the pastry is as follows. All the materials including the bilberry puree are mixed until gluten of the flour is optimized. The materials are put in a casing so that they do not dry, and the casing is covered with a lid to perform primary leavening in a place at about 30° C. for about 50 minutes. However, since this blend is rich as compared with another dough, this dough hardly swells. The dough is put in a refrigerator and rested for 35 to 45 minutes. The butter to be interfolded is put in the dough removed from the refrigerator, and interfolded into several layers. The dough is again rested in the refrigerator for 35 to 45 minutes, and ingredients are held in the dough, or mounted on the dough and formed. The dough is coated with an egg for glazing, and baked at 200 to 220° C. for 20 to 25 minutes.

The materials of the Chinese bread are 25 g of hard flour, 75 g of soft flour, 10 g of sugar, 4 g of sesame oil, 0.6 g of salt, 2 g of dry yeast and 25 g of water. When 30 g of bilberry puree is added, the bread can be colored bluish purple.

A procedure of manufacturing the Chinese bread is as follows. All the materials including the bilberry puree are mixed until gluten of the flour is optimized. The materials are put in a casing so that they do not dry, and the casing is covered with a lid to perform primary leavening in a place at about 40° C. for about 60 minutes until a size of the dough becomes approximately doubled. The dough is divided and rested for about ten minutes. If the dough is manually shredded during the dividing, a section of the dough is roughened without being smoothened. Therefore, a spatulate utensil such as a scraper is used. The dough is extended into a circular shape having a diameter of about 10 cm, stuffed with ingredients and firmly closed. Secondary leavening is performed in a humid and warm place for about 20 minutes. After the leavening, the dough is steamed over high heat by use of a steaming basket or steamer.

The materials of the American muffin are 150 g of hard flour, 120 g of soft flour, 90 g of sugar, 45 g of butter, 2.5 g of salt, 30 g of water, one whole egg, 3 g of baking powder and 45 g of salad oil. When 100 g of bilberry puree is added, the muffin can be colored bluish purple.

A procedure of manufacturing the American muffin is as follows. All the materials are mixed. It is to be noted that the sugar, egg and bilberry puree are well mixed. The flour is put and roughly mixed without being excessively stirred. The dough is slightly rested, an appropriate amount of the dough is put in a mold or a cup, and the dough is baked at about 180° C. for 25 to 30 minutes.

The materials of the bagel are 100 g of hard flour, 5 g of sugar, 3 g of salt, 2 g of dry yeast, 25 g of water, 5 g of vegetable oil and 0.3 g of malt. When 25 g of bilberry puree is added, the bagel can be colored bluish purple.

A procedure of manufacturing the bagel is as follows. All the materials including the bilberry puree are mixed until gluten of the flour is optimized. The materials are put in a casing so that they do not dry, and the casing is covered with a lid to perform primary leavening in a place at about 30° C. for about 50 minutes until a size of the dough becomes approximately doubled. The dough is divided and rested for ten minutes. The dough is extended and rounded. Secondary leavening is performed for 20 to 30 minutes. After the leavening, the dough is boiled in boiling water and baked in an oven at a temperature of 200 to 250° C. for 12 to 18 minutes.

Moreover, as another method, there is a case where the formed dough is quickly stored in the refrigerator, leavened for about one day, returned to room temperature the next day, boiled and then baked. It is to be noted that in a blend, any oil or fat is not used in some case. Furthermore, the dough is sometimes baked under much steam in the oven without being boiled. In this case, to improve texture, a dough improving agent is added in many cases.

A sweet blend list 6d shows amounts of materials to be added and baking and heating conditions, the materials being to be blended with the pound cake, the steamed cake, the sponge cake and the pancake. A sweet blend list 6e shows amounts of materials to be added and baking and heating conditions, the materials being to be blended with the biscuit, the waffle, the cream puff pastry and the scone.

The materials of the pound cake are 150 g of soft flour, 120 g of sugar, 120 g of butter, one whole egg and 1 g of baking powder. When 50 g of bilberry puree is added, the cake can be colored bluish purple.

A procedure of manufacturing the pound cake is as follows. The materials including the bilberry puree are mixed. They are baked at 180° C. for 40 minutes.

The materials of the steamed cake are 100 g of soft flour, 100 g of sugar, 30 g of salad oil, one whole egg and 4 g of baking powder. When 50 g of bilberry puree is added, the bread can be colored bluish purple.

A procedure of manufacturing the steamed cake is as follows. The egg, sugar and salad oil are put in a bowl and well whisked. A mixture of soft flour and baking powder is added, and roughly mixed. The bilberry puree is added and mixed. A generous amount of water is put in a steamer, and steamed over high heat for 30 to 35 minutes. In a case where a bamboo skewer is stuck into the dough and any dough is not attached to the skewer, it can be considered that the cake has been steamed.

The materials of the sponge cake are 100 g of soft flour, 100 g of sugar, 30 g of butter, two whole eggs and 15 g of milk. When 60 g of bilberry puree is added, the cake can be colored bluish purple.

A procedure of manufacturing the sponge cake is as follows. The eggs are put in a bowl and beaten. The sugar is added and whisked until a character “9” can be written with a lifted dough. The soft flour is added, and the dough is roughly mixed as if it were cut while scooping the dough from bottom with a rubber spatula. The milk, melted butter and bilberry puree are put in order, and roughly and quickly mixed. A mold is coated with butter other than the above amount of the butter, and sprayed with the soft flour, and oven paper is laid on the bottom of the mold. The dough is poured into the mold while smoothing the dough with the spatula so that the surface of the dough becomes flat, and the dough is dropped from a height of about 10 cm several times to release air out of the dough. The dough is baked at 170° C. for 25 minutes by use of an oven. In a case where a bamboo skewer is stuck into the dough and any dough is not attached to the skewer, it can be considered that the cake has been baked.

The materials of the pancake are 100 g of soft flour, 30 g of sugar, one whole egg, 30 g of milk, 4 g of baking powder and 30 g of water. When 40 g of bilberry puree is added, the cake can be colored bluish purple.

A procedure of manufacturing the pancake is as follows. The egg and sugar are put in a bowl and well mixed. The milk, water and bilberry puree are added and mixed without being whisked if possible. A slight amount of salt is added to a mixture of the soft flour and the baking powder, and mixed in the bowl with a rubber spatula. It is to be noted that a powdery portion remaining in a periphery of the bowl is completely mixed. The dough is rested in a refrigerator for about 20 minutes if possible. A heated frying pan is detached from fire once, heat is roughly removed with a wetted kitchen cloth, and an appropriate amount of the dough is poured into the frying pan. The surface of the dough is baked over low heat for two to three minutes. When bubbles are made, the dough is turned over. The back surface is baked for two to three minutes, and the dough is heated up.

The materials of the biscuit are 130 g of soft flour, 33 g of sugar, 50 g of shortening and ⅓ of the whole egg. When 30 g of bilberry puree is added, the biscuit can be colored bluish purple.

A procedure of manufacturing the biscuit is as follows. The shortening and sugar are put in a bowl and well mixed. The beaten egg and the bilberry puree are added and mixed. The soft flour is divided into three portions, and they are added and roughly mixed. The dough is put in a vinyl pouch, extended into a thickness of 7 to 8 mm with a rolling pin or the like, and cooled in a refrigerator. The dough is cut out as desired with a die, and baked at 180° C. for 13 to 15 minutes.

The materials of the waffle are 100 g of soft flour, 30 g of sugar, 50 g of butter, one whole egg, 50 g of dairy cream and 5 g of baking powder. When 50 g of bilberry puree is added, the waffle can be colored bluish purple.

A procedure of manufacturing the waffle is as follows. The materials including the bilberry puree are mixed. It is to be noted that if necessary, about 50 g of salad oil may be added. The front and back surfaces of the dough are baked using an oven for exclusive use in the waffle for three to four minutes.

The materials of the cream puff pastry are 100 g of soft flour, 70 g of butter, two whole eggs and 50 g of water. When 50 g of bilberry puree is added, the pastry can be colored bluish purple. It is to be noted that the cream puff pastry is a dough of a puff shell portion.

A procedure of manufacturing the cream puff pastry is as follows. The butter, water and bilberry puree are put in a pun, and boiled over medium heat. The heating is stopped, and the dough is well kneaded and mixed with a spatula while adding the soft flour. The dough is again heated over the medium heat, and kneaded and mixed for three to four minutes to fly a moisture until the dough is not attached to the pan. The heating is stopped, and a beaten egg is mixed in small divided portions several times. The dough is put in a pastry bag, squeezed onto a baking sheet of an oven, and baked at 180 to 210° C. for 15 to 25 minutes. While a temperature of the oven is gradually lowered, the dough is completely and firmly dry-baked.

The materials of the scone are 100 g of soft flour, 24 g of sugar, 34 g of butter. ⅕ of the whole egg and 6 g of baking powder. When 30 g of bilberry puree is added, the scone can be colored bluish purple.

A procedure of manufacturing the scone is as follows. The butter cooled beforehand and the soft flour well mixed and sieved are mixed. The whole dough is mixed while finely crushing the butter with fingertips. The dough is lightly rubbed with both hands, and dry-powdered. However, if the butter melts, the scone cannot be finished to be crispy. Therefore, the operation is quickly performed. The sugar is added, and the beaten egg and bilberry puree are put and well mixed with a spatula. When a powdery state is eliminated and the dough is integrated, the dough is wrapped and rested in a refrigerator for about one hour. The dough is floured and extended into a thickness of 2 cm with a rolling pin. The dough is die-cut, coated with an egg for glazing or milk and baked at about 180° C. for 15 to 20 minutes.

In FIGS. 2, 3 and 4, it is considered that the pancake and the pound cake are largely influenced by alkalization. However, they can be colored bluish purple without any problem, if bilberries are added in an amount of 5 to 30%, preferably 10 to 18% with respect to a weight of the dough.

In addition, marzipan can be colored brightly bluish purple. It is to be noted that the marzipan is a sweet prepared by mixing almond powder and sugar and rolling the mixture into a pasted state, and the marzipan can be worked as a cake or bread ornament into various shapes such as a flow shape and a doll shape.

Moreover, in a case where the bilberry puree is added to Japanese cake such as a dumpling or a rice cake, or a fish-shaped pancake stuffed with bean jam instead of adding a moisture, or a case where the bilberry puree is added to buckwheat noodles, wheat noodles or pastas, the food can similarly be colored brightly bluish purple.

Heretofore, an artificial coloring agent has been added in many cases. However, when a constant amount of the bilberry puree including a large amount of anthocyanin is added to the processed flour food, the food can be colored brightly bluish purple. In addition, the food is highly safe.

As described above, according to the processed flour food of the present invention containing the added bilberries and the method of coloring the food, when 5 to 30%, preferably 10 to 18% of bilberries are added to the processed flour food, the processed flour food can be colored brightly bluish purple.

A cost price of the bread colored with the bilberries or the like can be reduced as much as 52% at maximum, 27% at minimum as compared with the bread colored with the blueberries. Since costs can largely be reduced, the bread colored with the bilberries might largely be accepted by the market.

The bilberries contain the anthocyanin dyestuff which is about five-fold at maximum, about two-fold at minimum as compared with the blueberries. An effect of a health functionality food can be expected such as an eyesight improving effect and an antioxidant function.

Since an influence of pectin included in the bilberries remarkably develops in a manufacturing process, leavening and baking of the bread are improved, and a water retaining property, texture, long life, resistance to mechanical processing and the like can be expected.

The bilberries include a content of the anthocyanin dyestuff which is remarkably larger than that of the blueberries, and has a strong acidity around pH 2.0. Therefore, even in a case where the bilberries are used together with an alkaline material, discoloration to grayish blue can be reduced.

The bilberry puree is stabilized even when heated at 200° C. or more for 40 minutes or more, or even when mixed as health drink with water. Therefore, as a natural coloring agent, the puree can broadly be utilized in food, beverage, feedstuff, cosmetic or medical supply.

According to a step of adding the bilberries as the puree to the processed flour food, the processed flour food can be colored brightly bluish purple by the most commercially hygienic, efficient and economic method.

In addition to the bread using the flour and the like, grain crops (barley, foxtail millet, oat, millet, wheat powder, buckwheat powder, pasta, corn, rye and barnyardgrass) can be colored because they contain a large amount of starchy content. The present invention is usable in a bread in which rice powder is utilized.

### INDUSTRIAL APPLICABILITY

Since the present invention is constituted as described above, the following effects are obtained.

Firstly, when 5 to 30%, preferably 10% to 18% of bilberries are added to a processed flour food, the processed flour food can be colored brightly bluish purple.

Secondly, a cost price of a bread colored with the bilberries or the like can be reduced as much as 52% at maximum, 27% at minimum as compared with a bread colored with blueberries. Since costs can largely be reduced, the bread colored with the bilberries might largely be accepted by the market.

Thirdly, the bilberries contain an anthocyanin dyestuff which is about five-fold at maximum, about two-fold at minimum as compared with the blueberries. An effect of a health functionality food can be expected such as an eyesight improving effect and an antioxidant function.

Fourthly, since an influence of pectin included in the bilberries remarkably develops in a manufacturing process, leavening and baking of the bread are improved, and a water retaining property, texture, long life, resistance to mechanical processing and the like can be expected.

Fifthly, the bilberries include a content of the anthocyanin dyestuff which is remarkably larger than that of the blueberries, and has a strong acidity around pH 2.0. Therefore, even in a case where the bilberries are used together with an alkaline material, discoloration to grayish blue can be reduced.

Sixthly, a bilberry puree is stabilized even when heated at 200° C. or more for 40 minutes or more, or even when mixed as health drink with water. Therefore, as a natural coloring agent, the puree can broadly be utilized in food, beverage, feedstuff, cosmetic or medical supply.

Seventhly, through a step of adding the bilberries as the puree to the processed flour food, the processed flour food can be colored brightly bluish purple by the most commercially hygienic, efficient and economic method.

1. A method of coloring a processed flour food with bilberry puree, in which the bilberry puree is thawed in a refrigerator and added in an amount of 5% to 30% with respect to a weight of all materials of the processed flour food to color the processed flour food brightly bluish purple, the bilberry puree being prepared by: a harvesting step of washing, with water, bilberries which have naturally grown wild, then drying the bilberries with sent air, then freezing the bilberries at minus 18° C. to minus 30° C., uniformly scattering the frozen bilberries with a crushing machine, removing foreign matters by leaf removing, stem removing, size selection, a ripeness inspection, laser removing, on-the-spot visit or an inspection with a metal detector, and then freezing the bilberries at minus 18° C. to minus 30° C.; a processing step of finely crushing the bilberries frozen after the harvesting step with a mixer for three to ten minutes, adding 0% to 10% of aroma to the finely crushed bilberries, and adding 0% to 60% of sugar to the bilberries to mix them well for one to two minutes; and a storing step of sterilizing each constant amount of the bilberries packed after the processing step by one of low-temperature sterilization in which the bilberries are left to stand at a temperature of 62° C. to 65° C. for 30 minutes, high-temperature sterilization in which they are left to stand at a temperature of 75° C. for 15 minutes, high-temperature sterilization in which they are left to stand at a temperature of 100° C. for one minute, and super high temperature short time sterilization in which they are left to stand at a temperature of 120° C. to 130° C. for two seconds, cooling the bilberries, passing the bilberries through a metal detector, checking mixture of foreign matters, and then storing the frozen bilberries at minus 18° C. to minus 30° C.

2. The method of coloring the processed flour food with the bilberry puree according to claim 1, characterized in that the processed flour food is one of a roll of butter bread, a loaf of bread, the French bread, the English muffin, a sweet bun, a melon coating, a yeast doughnut, a brioche, a croissant, the Danish pastry, a pastry, the American muffin, the Chinese bread, a bagel, a pound cake, a steamed cake, a sponge cake, a pancake, a biscuit, a waffle, a cream puff pastry and a scone.

3. (canceled)

4. (canceled)

5. (canceled)
